(19) United States
(12) Patent Application Publication
(10) Pub. No.: US 2013/0276649 A1
(43) Pub. Date: Oct. 24, 2013

(54) PRESS

(71) Applicants: Mirko Vandieken, Schieder-Schwalenberg (DE); Wilhelm Grabbe, Lemgo (DE)

(72) Inventors: Mirko Vandieken, Schieder-Schwalenberg (DE); Wilhelm Grabbe, Lemgo (DE)

(73) Assignee: PHOENIX CONTACT GMBH & CO. KG, Blomberg (DE)

(21) Appl. No.: 13/884,747

(22) PCT Filed: Nov. 11, 2011
(86) PCT No.: PCT/EP2011/069984

§ 371 Date: Jul. 12, 2013

(30) Foreign Application Priority Data
Nov. 12, 2010 (DE) 10 2010 060 524.7

(51) Int. Cl. F16P 3/00; B30B 15/28

(52) U.S. Cl. CPC F16P 3/008; B30B 15/28
USPC 100/347

(57) ABSTRACT

The invention relates to a press having a coverable working region in which a pressing process can be carried out by applying compressed air or fluid to the press, a protective device for covering the working region and a pipe conduit for transporting the compressed air or the fluid, wherein a first part of the pipe conduit is arranged on the protective device, a further part of the pipe conduit is arranged on the press, and the protective device is configured in such a way that by removing the protective device from the working region the first part of the pipe conduit is disconnected from the further part of the pipe conduit. The invention makes it possible that the press is not supplied energetically with compressed air or fluid for carrying out the pressing process until after the working region has been closed with the protective device.

### FIELD

The invention relates to a press, having a coverable working region in which a pressing process can be carried out by applying compressed air or liquid to the press, a protective device for covering the working region, and a pipeline for transporting the compressed air or the liquid.

### BACKGROUND

A large number of presses that can be operated with compressed air or liquid and that comprise protective devices for covering the working region, in which the pressing process can be carried out and which generally constitutes a danger zone, are known from the prior art. Many are used as protective devices or what are known as two-hand controls, with which both of an operator's hands have to be applied to the respective switches of the two-hand control so that the pressing process can start. With two-hand controls of this type, a free hand or another body part of the operator should not enter the danger zone of the press during the pressing process.

For correct and reliable functioning, the two-hand controls known from the prior art require a complex control unit of the press, which is often susceptible to faults. This susceptibility to faults for example means that on the one hand the required safety categories of the press cannot be maintained, and on the other hand cost-intensive interruptions of production lines containing the press may occur.

The object of the invention is to specify a press having an improved protective device, which can be produced in a particularly simple and cost-effective manner.

The object is achieved in accordance with the invention by the features in the independent claims. Advantageous embodiments of the invention are specified in the dependent claims.

### SUMMARY

The object is achieved by a press, having a coverable working region in which a pressing process can be carried out by applying compressed air or liquid to the press, a protective device for covering the working region, and a pipeline for transporting the compressed air or the liquid, wherein a first part of the pipeline is arranged on the protective device, a further part of the pipeline is arranged on the press, and the protective device is formed in such a way that, by removing the protective device from the working region, the first part of the pipeline is separated from the further part of the pipeline.

In accordance with the invention, a press having a protective device is therefore specified, which achieves the safety required by standard EN 954, in particular at least safety category 2 or 3, in a particularly simple manner and without much additional installation effort. For example, the press according to the invention can be operated pneumatically or hydraulically, that is to say for example by means of compressed air or oil. A person skilled in the art may accordingly provide any pipeline known from the prior art for transporting the compressed air or liquid. Furthermore, the compressed air and/or liquid can be formed as a fluid, a pressure medium or other gases known to a person skilled in the art. In particular, a press having the highest safety category 4 of the Machinery Directive, can be formed with the solution according to the invention when air is used as a pressure medium and when the air flows out audibly with an uninterrupted pipeline. Due to an embodiment of this type, the safety function can always be preserved and a fault can be identified in good time, which corresponds to the required system behavior for this safety stage or safety category.

The working region is preferably arranged in the press in such a way that the working region can be covered or closed at least in part, and most preferably completely, by the protective device. In other words, it is preferable in accordance with the invention for the working region forming the danger zone of the press to be closable by the protective device in such a way that the operator does not have to move his hand into the danger zone of the press during a pressing process.

In accordance with the invention, the pipeline supplying compressed air or liquid to the press is separated by removing or taking away the protective device from the working region, that is to say by means of a mechanical intervention. In other words, the invention makes it possible for the press to be supplied energetically with compressed air or liquid for carrying out the pressing process only once the protective device has been fitted correctly to the working region, that is to say for example once the working region has been closed by the protective device in such a way that the operator cannot reach the danger zone of the press. Accordingly, in another case in which the protective device according to the invention has been fitted incorrectly to the working region, the press cannot be supplied energetically in order to carry out the pressing process, and therefore an operator or another person is not endangered by workpieces or dies fitted on the press. However, in accordance with a particularly preferred embodiment of the invention, the first part of the pipeline is connected inseparably, preferably mechanically fixedly, to the protective device. Most preferably, the first part of the pipeline is fitted on the side of the protective device opposite the working region. For example, the pipeline can be passed through the protective device or can be connected inseparably to the protective device by clamps or other fastening means known from the prior art.

The pipeline is most preferably at one end of the protective device guided through the protective device from the side of the protective device facing the working region and at the other end of the protective device is again guided through the protective device from the side of the protective device facing away from the working region, such that the pipeline formed in this way also forms a “grip” for actuating the protective device. Furthermore, it is preferable for the protective device to be formed as a transparent protective screen, such that the operator can see through the protective device into the working region of the press during a pressing process. The working region can be formed as a cubic body, for example as a cuboid or as a rectangle made of metal or plastic, which, in the region of the protective device, comprises an opening that can be covered by the protective device.

In accordance with a particularly preferred embodiment of the invention, the pipeline comprises a coupling valve for connecting the first part of the pipeline to the further part of the pipeline, wherein the coupling valve is formed in such a way that the coupling valve interrupts the transport of the compressed air or of the liquid in the pipeline when the protective device is removed from the working region. In this regard, it is also preferable for the coupling valve to be formed as a self-closing valve or as a quick-action coupling. In an embodiment of this type, the protective device according to the invention can be particularly easily removed from the working region of the press or connected to the working region of the press. Furthermore, it is most preferred if the press comprises two coupling valves, such that the first part of the pipeline can be connected at each end to the press via a coupling valve.

In a further preferred embodiment of the invention, the press comprises a lower die, wherein the lower die is arranged displaceably in the working region, the lower die for equipping the press is removable from the working region, and the lower die is embodied in such a way that, by removing the lower die from the working region, the application of compressed air or liquid to the press is interrupted. Furthermore, it is particularly preferred for the lower die to be embodied in such a way that, by removing the lower die from the working region, the pipeline is interrupted. Here, the further part of the pipeline may comprise a valve, wherein the valve during removal of the lower die from the working region interrupts the supply of compressed air or liquid to the pressing cylinder. The valve may be formed as an opening in the further part of the pipeline.

The lower die is most preferably arranged displaceably on a slide. Here, the lower die may be formed as any lower die for a press known from the prior art. In other words, in accordance with this embodiment of the invention, it is preferable for the press not to be supplied energetically with compressed air or liquid when the lower die is removed from the working region of the press. Here, the lower die and the protective device can be formed in such a way that, when removing the lower die from the working region, the protective device is not removed from the working region. In accordance with these embodiments, the press according to the invention can thus be equipped or loaded with the lower die and a workpiece, which for example can be arranged thereon and is to be worked by the pressing process.

In accordance with a further embodiment of the invention, it is preferable that, when the protective device covers the working region, the pressing process starts once the lower die has been fully slid into the working region. In accordance with this embodiment, once the lower die has been slid into the working region and once the lower die has reached an end position, it is thus preferable for the pressing process to be started, for example by a switch, which is arranged in the end position of the lower die, for triggering the pressing process, such that no time is lost due to actuation of an additional trigger device to start the pressing process.

In this regard, it is preferable in accordance with a further embodiment of the invention for the press to comprise a locking device and an upper die in the working region, wherein the locking device is formed in such a way that the locking device locks the lower die, the upper die and/or the protective device together once the pressing process begins. Here, the upper die may be embodied as any upper die for a press known from the prior art. The locking device most preferably locks the lower die, the upper die and/or the protective device mechanically in such a way that a movement reversal of the lower die carried out by hand, that is to say for example a removal of the lower die from the working region, is made impossible during the pressing process.

The object of the invention is also achieved by a protective device for a press that can be operated with compressed air or liquid, comprising a first part, arranged on the protective device, of a pipeline for transporting the compressed air or the liquid, wherein the protective device for covering a working region of the press is formed in such a way that, by removing the protective device from the working region, the first part of the pipeline is separated from a further part of the pipeline.

In accordance with a further preferred embodiment of the invention, the pipeline comprises a coupling valve for connecting the first part of the pipeline to a further part of the pipeline, wherein the coupling valve is formed in such a way that the coupling valve, during removal of the protective device from the working region, interrupts the transport of the compressed air or of the liquid in the pipeline. Preferred embodiments and advantages of the protective device according to the invention will become clear to a person skilled in the art by analogy with the above explanations and embodiments of the press according to the invention.

The object is also achieved by a method for covering a working region of a press that can be operated with compressed air or liquid, comprising a protective device for closing the working region of the press and a first part, arranged on the protective device, of a pipeline for transporting the compressed air or the liquid, said method comprising the following step: interrupting the first part of the pipeline during a removal of the protective device from the working region of the press.

In accordance with the invention, when the protective device is removed from the working region, the supply of compressed air or liquid to the press by carrying out a pressing process is thus interrupted.

Preferred embodiments and advantages of the method according to the invention will become clear to a person skilled in the art by analogy with the above explanations and embodiments of the press according to the invention and/or protective device according to the invention.

### BRIEF DESCRIPTION OF THE DRAWINGS

The invention will be explained in greater detail hereinafter with reference to the drawing, in which:

FIG. 1 shows a perspective view of a press according to a preferred exemplary embodiment of the invention,

FIG. 2 shows a perspective view of the press according to the preferred exemplary embodiment of the invention with the protective device removed from a working region,

FIG. 3 shows a plan view of the press according to the preferred exemplary embodiment of the invention,

FIG. 4 shows a plan view of the press according to 35 the preferred exemplary embodiment of the invention with a removed lower die,

FIG. 5 shows a plan view of the press according to the preferred exemplary embodiment of the invention with the protective device removed from the working region, and

FIG. 6 shows a perspective rear view of part of the press with the lower die removed from the working region.

### DETAILED DESCRIPTION

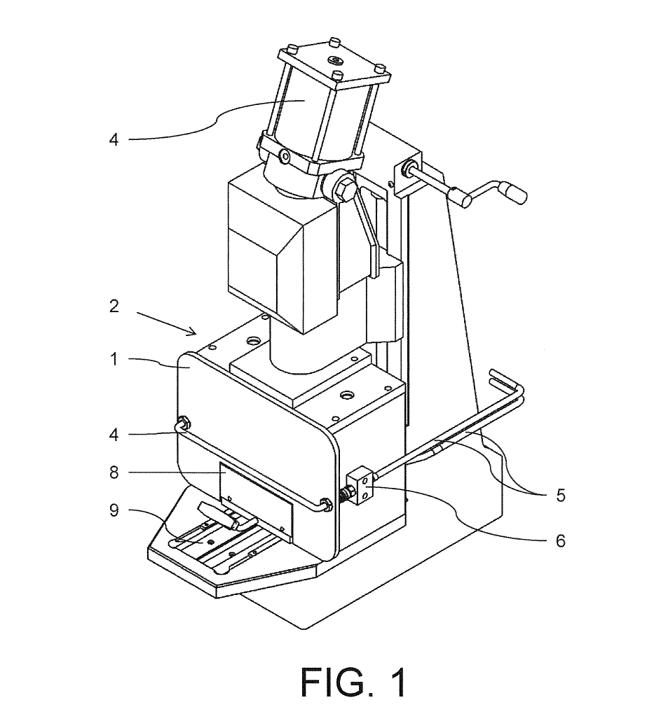

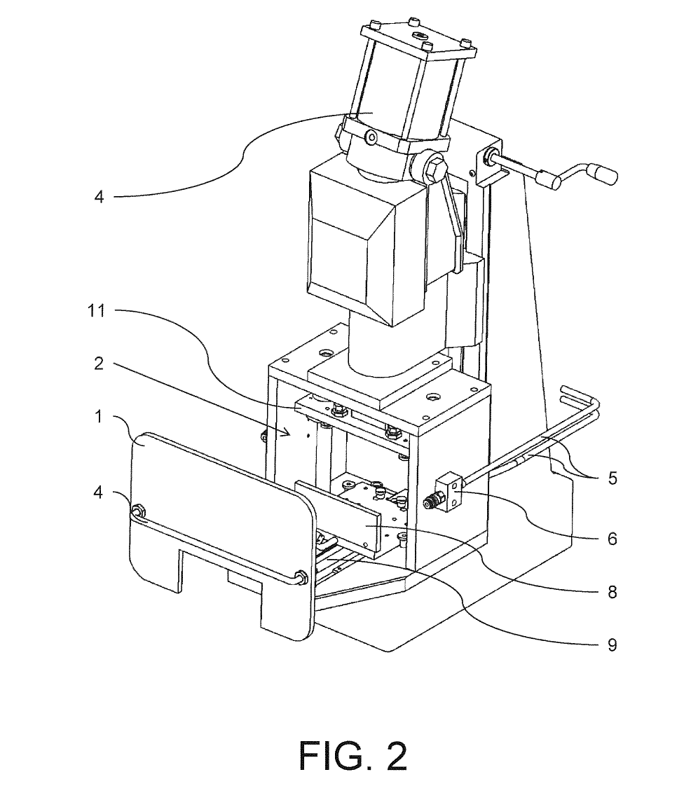

A press according to a preferred exemplary embodiment of the invention can be seen in perspective view from FIGS. 1 and 2, comprising a protective device 1 for covering a working region 2 of the press, in which a pressing process can be carried out by applying compressed air or liquid, for example oil, to the press.

Whereas FIG. 1 shows a working region 2 covered by the protective device 1, an open working region 2 can be seen from FIG. 2, wherein the protective device 1 has been removed from the working region 2. In accordance with the present exemplary embodiment of the invention, the protective device 1, which for example is formed as a metal or plastic plate, is embodied in such a way that the protective device 1 completely closes the working region 2 of the press when said working region 2 is covered by the protective device 1, such that a free hand of an operator cannot reach the working region 2, that is to say cannot reach the danger zone of the press.

The device triggering the pressing process of the press, for example a pressing cylinder 3, is supplied with compressed air or liquid via a pipeline 4, 5 in order to carry out the pressing process, in such a way that a first part of the pipeline 4 is arranged inseparably on the protective device, whereas a further part of the pipeline 5 is arranged on the press.

In accordance with the invention, the protective device 1 is embodied in such a way that, by removing the protective device 1 from the working region 2 of the press, the first part of the pipeline 4 is separated from the further part of the pipeline 5. As a result, compressed air or liquid is then only applied to the pressing cylinder 3 when the protective device 1 covers the working region 2 of the press in such a way that the danger zone present in the working region 2 and in which the pressing process can be carried out is not accessible for a free hand of an operator. In other words, the press is then not supplied energetically with compressed air or liquid when the protective device 1 does not “correctly” cover the working region 2.

To connect the first part of the pipeline 4 to the further part of the pipeline 5, two coupling valves 6 are provided, wherein the coupling valves 6 when the protective device 1 is removed from the working region 2 of the press interrupts the transport of the compressed air or of the liquid in the pipeline 4, 5. The coupling valves 6 are formed for this purpose for example as self-closing valves and/or quick-action couplings.

In accordance with the preferred embodiment of the invention, as can be seen from FIGS. 1 to 5, the further part of the pipeline 5 is arranged at least in part on an outer face of the working region 2, and the first part of the pipeline 4 is arranged on the side of the protective device 1 facing away from the working region 2. The pipeline 4, 5 is thus guided substantially externally around the working region 2, in such a way that the first part of the pipeline 4 at one end of the protective device 1 is guided through the protective device 1, is guided along the protective device 1, and at the other end of the protective device 1 is again guided through the protective device 1. A particularly simple and fixed mechanical connection between the first part of the pipeline 4 and the protective device 1 is thus achieved.

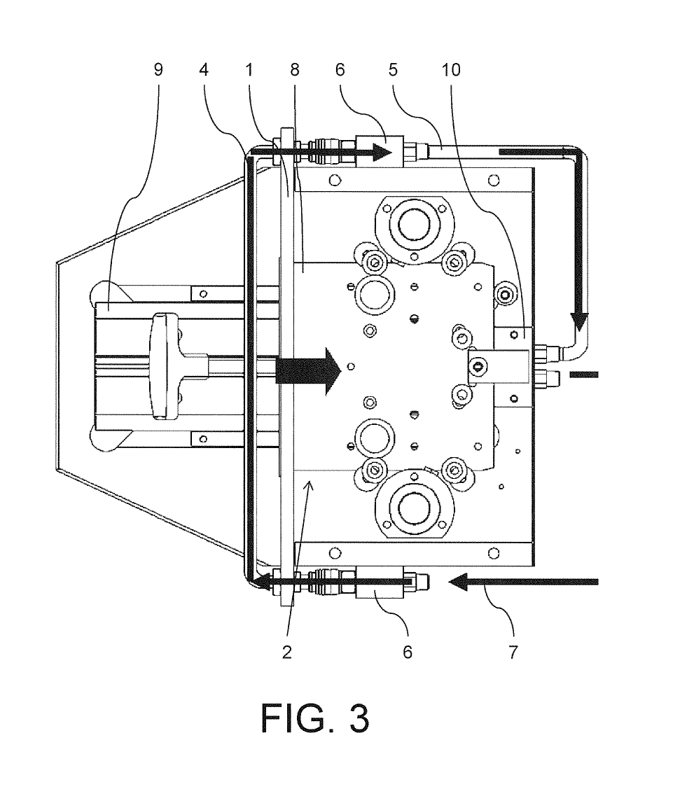

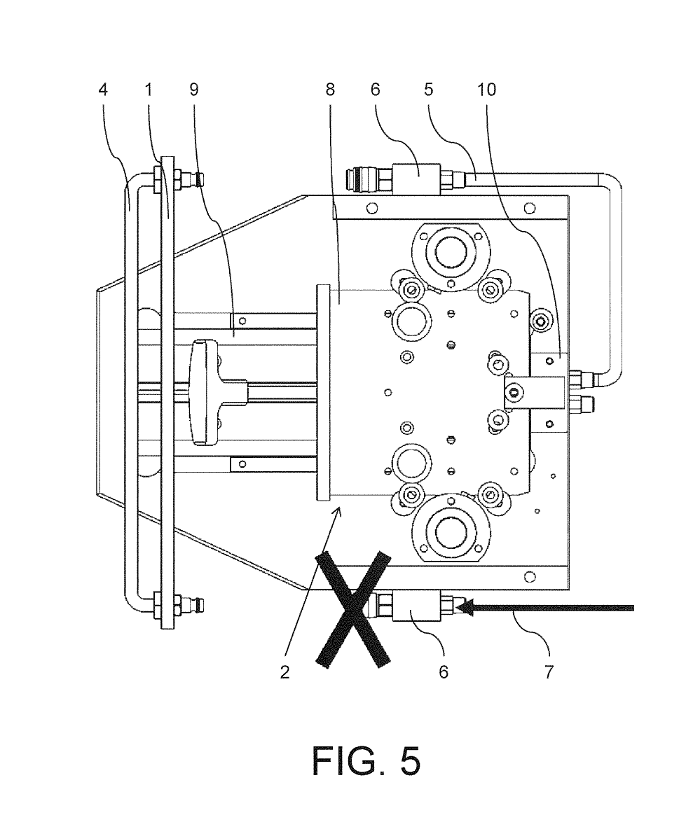

FIGS. 3 to 5 show the press in a plan view and illustrate the foregoing: the application of compressed air or liquid to the press, illustrated by the arrow 7, is achieved by means of the pipeline 4, 5, wherein the further part of the pipeline 5 is connected via the coupling valve 6 to the first part of the pipeline 4 when the protective device 1 covers the working region 2 of the press. By contrast, a state in which the protective device 1 does not cover the working region 2 of the press, such that there is no connection between the further part of the pipeline 5 and the first part of the pipeline 4 can be seen from FIG. 5.

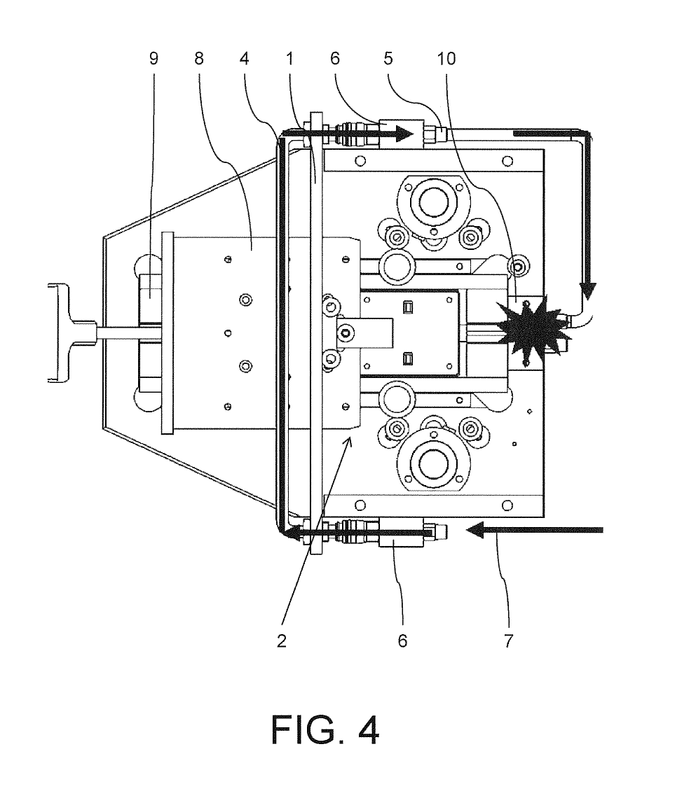

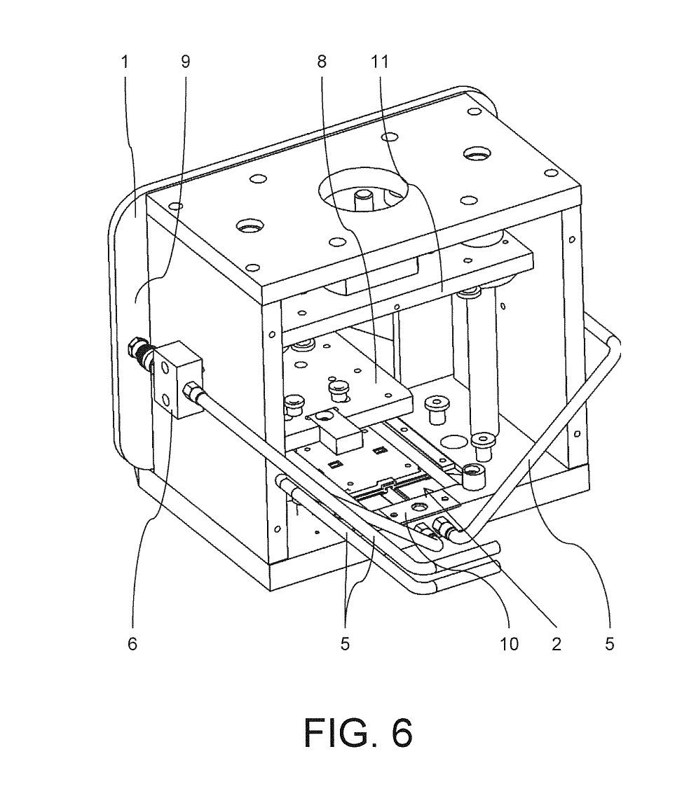

The press further comprises a lower die 8 for receiving a workpiece to be worked in the working region 2, wherein the lower die 8 is arranged displaceably in the working region on a slide 9 and the lower die 8, as is illustrated in FIG. 4, can be removed from the working region 2 of the press. To this end, the lower die 8 is embodied in such a way that, by removing the lower die 8 from the working region 2, the application of compressed air or liquid to the press is interrupted, for example in such a way that the further part of the pipeline 5 comprises a valve 10 and the valve 10 when the lower die 8 is removed from the working region 2 interrupts the supply of compressed air or liquid to the pressing cylinder 3. Here, the valve 10 can be embodied as an opening in the further part of the pipeline 5, as can be seen in FIG. 6. When the lower die 8 is slid into the working region 2 and once the lower die 8 has been slid in completely, the valve 10 is closed by the lower die 8, as can be seen in the plan view in FIG. 5, such that compressed air or liquid is applied to the pressing cylinder 3 of the press.

Furthermore, the lower die 8 is embodied in such away that, when the protective device 2 is closed, the pressing process begins once the lower die 8 has been slid fully into the working region 2. Furthermore, the press may comprise a locking device (not illustrated), and also an upper die 11, wherein the locking device locks the lower die 8, the upper die 11 and/or the protective device 1 together when the pressing process begins.

### LIST OF REFERENCE SIGNS

protective device 1
working region 2
pressing cylinder 3
first part of the pipeline 4
further part of the pipeline 5
coupling valve 6
arrow 7
lower die 8
slide 9
valve 10
upper die 11

What is claimed is:

1. A press, comprising:
a working region (2) that is coverable, wherein a pressing process can be carried out by applying a compressed air or liquid to the press,
a protective device (1) for covering the working region (2), and
a pipeline (4, 5) for transporting the compressed air or the liquid comprising a first part (4) arranged on the protective device (1) and a further part (5) arranged on the press,
wherein the protective device (1) is embodied in such a way that when the protective device (1) is removed from the working region (2), the first part of the pipeline (4) is separated from the further part of the pipeline (5).

2. The press according to claim 1, wherein the first part of the pipeline (4) is inseparably connected to the protective device (1).

3. The press according to claim 2, wherein the pipeline (4, 5) further comprises a coupling valve (6) for connecting the first part of the pipeline (4) to the further part of the pipeline (5); and
wherein the coupling valve (6) is embodied in such a way that, when the protective device (1) is removed from the working region (2), the coupling valve (6) interrupts the transport of the compressed air or of the liquid in the pipeline (4, 5).

4. The press according to claim 3, further comprising a lower die (8) for equipping the press, wherein the lower die (8) is displaceably arranged in the working region (2);
wherein the lower die (8) can be removed from the working region (2); and
wherein the lower die (8) is embodied in such away that, when the lower die (8) is removed from the working region (2), the application of the compressed air or liquid to the press is interrupted.

5. The press according to claim 4, wherein the lower die (8) is embodied in such a way that, when the lower die (8) is removed from the working region (2), the pipeline (4, 5) is interrupted.

6. The press according to claim 5, wherein the lower die (8) is embodied in such a way that, when the protective device (1) covers the working region (2), the pressing process starts once the lower die (8) has slid fully into the working region (2).

7. The press according to claim 6, further comprising a locking device and an upper die (11) arranged in the working region (2), wherein the locking device is embodied in such a way that, when the pressing process begins, the locking device locks the lower die (8), the upper die (11) and/or the protective device (1) together.

8. A protective device (1) for a press operable with a compressed air or liquid, comprising:
a first part of a pipeline (4) arranged on the protective device (1) and configured to transport the compressed air or the liquid;
wherein the protective device (1) is configured to cover a working region (2) of the press; and
wherein the protective device is embodied in such a way that, when the protective device (1) is removed from the working region (2), the first part of the pipeline (4) is separated from a further part of the pipeline (5).

9. The protective device according to claim 8, wherein the pipeline (4,5) further comprises a coupling valve (6) for connecting the first part of the pipeline (4) to the further part of the pipeline; and
wherein the coupling valve (6) is embodied in such a way that, when the protective device (1) is removed from the working region (2), the coupling valve interrupts the transport of the compressed air or of the liquid in the pipeline (4, 5).

10. A method for covering a working region (2) of a press operable with a compressed air or liquid, wherein the press further comprises a protective device (1) for closing the working region (2), and a first part of a pipeline (4) arranged on the protective device (1) for transporting the compressed air or the liquid, said method comprising:
interrupting the first part of the pipeline (4) when the protective device (1) is removed from the working region (2) of the press.
